(19) United States
(12) Patent Application Publication
(10) Pub. No.: US 2008/0074628 A1
(43) Pub. Date: Mar. 27, 2008

(54) PROJECTOR

(75) Inventor: Koichi AKIYAMA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/850,139

(22) Filed: Sep. 5, 2007

(30) Foreign Application Priority Data
Sep. 25, 2006 (JP) 2006-258821

(51) Int. Cl. G03B 21/28

(52) U.S. Cl. 353/98

(57) ABSTRACT

A projector includes a light source device that includes: a light emission tube which has a tube spherical portion and a pair of sealing portions, and a reflector which reflects light emitted from the light emission tube toward an illumination-receiving area; an electro-optic modulating device that modulates illumination light emitted from the light source device according to image information, and a projection optical system that projects light modulated by the electro-optic modulating device. A transmission increasing film is formed on an area of the outside surface of the tube spherical portion containing a lower side peak with respect to the gravity. The transmission increasing film is not formed on an area of the outside surface of the tube spherical portion containing an upper side peak with respect to the gravity. The transmission increasing film has characteristics that transmittance of an area coated with the transmission increasing film for light in a visible range is higher than an area having no coating of the transmission increasing film.

### BACKGROUND

1. Technical Field

The present invention relates to a projector.

2. Related Art

According to a light source device of related art included in a projector, the entire outside surface of a tube spherical portion of a light emission tube is coated with anti-reflection film (for example, see JP-A-4-368768). The anti-reflection film has characteristics that its reflectance for light in a visible range is lower than that for light having wavelength out of the visible range. Since the entire outside surface of the tube spherical portion of the related-art light source device is covered with the anti-reflection film, reflection loss of visible light passing through the outside surface (surface) of the tube spherical portion is reduced. Thus, light utilization efficiency improves, and therefore luminance of the projector including the related-art light source device increases.

According to the light source device of the related art, the anti-reflection film is so designed as to greatly reduce reflectance for light in the visible range. However, no consideration is given to light in the wavelength range other than the visible range (such as ultraviolet and infrared ranges), and reflectance for light in the range other than the visible range is relatively high. In this case, the temperature of the entire tube spherical portion increases since a part of light in the other range reflected by the anti-reflection film is converted into heat. Moreover, a part of light passing through the anti-reflection film is absorbed by the anti-reflection film, and the light absorbed by the anti-reflection film is converted into heat. As a result, the temperature of the entire tube spherical portion rises.

Therefore, the problem that the temperature of the entire tube spherical portion increases (first problem) arises from the related-art light source device due to the presence of the anti-reflection film on the entire outside surface of the tube spherical portion.

According to the related-art light source device, particularly the temperature of the upper side peak of the tube spherical portion positioned on the upper side with respect to the gravity easily increases to a high temperature due to a neat convection and other factors. When the temperature exceeds the allowable level of the base material constituting the tube spherical portion, regional expansion or whitening may be caused at the upper side peak of the tube spherical portion. The whitening is a phenomenon that the material constituting the tube spherical portion turns white turbidity and loses transparency. When the regional expansion is produced on the tube spherical portion, the light emission tube may be broken due to its lowered strength. When whitening is produced on the tube spherical portion, whitened portion does not transmit light and thus heat is generated therefrom. As a result, the temperature of the light emission tube further rises, which may lead to breakage of the light emission tube.

More specifically, the problem that regional expansion or whitening may be caused at the upper side peak of the tube spherical surface positioned on the upper side with respect to the gravity (second problem) arises from the related-art light source device since particularly the temperature of the upper side peak of the tube spherical surface with respect to the gravity easily increases due to heat convection or other causes. When the regional expansion or whitening is produced at the upper side peak of the tube spherical surface, the life of the light source device decreases.

Concerning the above two problems, the first problem can be solved by cooling the light emission tube more intensively, i.e., by increasing revolutions of a cooling fan for cooling the light emission tube so that a larger volume of airflow can be supplied to the cooling fan, by using a cooling fan of larger size, or other methods. However, larger noise is generated when the airflow volume of the cooling fan is increased by raising the revolutions and the size of the unit and the manufacturing cost increase when the larger cooling fan is used. It is therefore not a preferable method to intensify cooling for the light emission tube.

Alternatively, the first problem of the above two problems can be solved by removing all of the anti-reflection film from the entire outside surface of the tube spherical portion. In this case, overall increase in temperature of the tube spherical surface is avoided, but transmittance for visible light passing through the outside surface of the tube spherical portion cannot be raised. Thus, improvement over light utilization efficiency is difficult.

In addition, the second problem cannot be solved by the methods of “intensifying cooling for the light emission tube” and “removing all of the anti-reflection film from the entire outside surface of the tube spherical portion”.

### SUMMARY

All advantage of some aspects of the invention is to provide a projector which can prevent overall increase in temperature of a tube spherical portion of a light emission tube included in a light source device of the projector while improving light utilization efficiency, and can prevent shortening of life span of the light source device.

A projector according to an aspect of the invention includes a light source device that includes a light emission tube which has a tube spherical portion containing a pair of electrodes, and a pair of sealing portions extending from both sides of the tube spherical portion. Both of the electrodes and the sealing portions are disposed along an illumination optical axis. The light source device further includes a reflector which is disposed near one of the sealing portions of the light emission tube and reflects light emitted from the light emission tube toward an illumination-receiving area. The projector further includes an electro-optic modulating device that modulates illumination light emitted from the light source device according to image information, and a projection optical system that projects light modulated by the electro-optic modulating device. A transmission increasing film is formed on an area of the outside surface of the tube spherical portion containing a lower side peak with respect to the gravity. The transmission increasing film is not formed on an area of the outside surface of the tube spherical portion containing an upper side peak with respect to the gravity. The transmission increasing film has characteristics that transmittance of an area coated with the transmission increasing film for light in a visible range is higher than an area having no coating of the transmission increasing film.

According to the projector of this aspect of the invention, the transmission increasing film is not formed on the area of the outside surface of the tube spherical portion containing the upper side peak with respect to the gravity. Since this area has no coating of anti-reflection film as well, overall increase in temperature of the tube spherical portion is prevented compared with the related-art light source device which has anti-reflection film on the entire outside surface of the tube spherical portion.

Moreover, according to the projector of this aspect of the invention which does not have the transmission increasing film on the area of the outside surface of the tube spherical portion containing the upper side peak with respect to the gravity, overall increase in temperature of the tube spherical portion can be reduced. Thus, the temperature of the upper side peak of the tube spherical portion does not rise, and regional expansion or whitening is not caused at the upper side peak of the tube spherical portion. As a result, the life of the light source device is not shortened.

Furthermore, according to the projector of this aspect of the invention which has the transmission increasing film on the area of the outside surface of the tube spherical portion containing the lower side peak with respect to the gravity, the transmittance of the area coated with the transmission increasing film for light in the visible range is higher than that of the area having no coating of the transmission increasing film. Thus, the entire light utilization efficiency increases.

Therefore, the projector provided according to this aspect of the invention can prevent overall increase in temperature of the tube spherical portion while increasing light utilization efficiency, and also prevent decrease in the life span of the light source device.

According to the projector of this aspect of the invention, it is preferable that the transmission increasing film has characteristics that transmittance of an area coated with the transmission increasing film for light in the range from 400 nm to 700 nm is higher than an area having no coating of the transmission increasing film.

In this case, visible light emitted from the lower side peak of the tube spherical portion can be more efficiently utilized.

According to the projector of this aspect of the invention, it is preferable that the transmission increasing film has a multi-layer film containing Ta₂O₅ and SiO₂.

In this case, the transmission increasing film has higher heat resistance, and maintains preferable and long-term transmittance increasing characteristics for the surface of the tube spherical portion of the light emission tube exposed to extremely high temperature.

According to the projector of this aspect of the invention, it is preferable that the transmission increasing film is formed on the outside surface of the tube spherical portion such that the surface area of the tube spherical portion coated with the transmission increasing film is equal to or larger than the surface area of the tube spherical portion having no coating of the transmission increasing film.

In this case, light utilization efficiency improves while preventing overall increase in temperature of the tube spherical portion and decrease in the life span of the light source device.

According to the projector of this aspect of the invention, it is preferable that the light source device further includes a reflection unit which is disposed near the other sealing portion of the light emission tube in such a condition as to cover the outside surface of the illumination-receiving area side in the tube spherical portion, and reflects light emitted from the light emission tube such that the light can be directed toward the light emission tube.

By providing the reflection unit on the sealing portion of the light emission tube, improvement over light utilization efficiency and miniaturization of the reflector are achieved. Consequently, the high-luminance and compact projector can be provided. However, since substantially half of the tube spherical portion is covered by the reflection unit, the temperature of the tube spherical portion of the projector having the reflection unit on the sealing portion of the light emission tube easily rises compared with a projector having no reflection unit of this type.

According to the projector of this aspect of the invention, overall increase in temperature of the tube spherical portion is prevented as described above. Therefore, this advantage is particularly effective for the projector which has the reflection unit on the sealing portion of the light emission tube.

In the projector having the reflection unit on the sealing portion of the light emission tube, light emitted from the light emission tube and reflected by the reflection unit passes through the outside surface of the tube spherical portion several times until the light emitted from the light emission tube and reflected by the reflection unit again passes through the inside of the light emission tube and enters the reflector.

As discussed above, the transmittance of the outside surface of the tube spherical portion for visible light passing therethrough is raised. Thus, this advantage is particularly effective for the projector which has the reflection unit on the sealing portion of the light emission tube.

According to the projector which has the reflection unit on the sealing portion of the light emission tube, a space is produced between the tube spherical portion and the reflection unit. In this case, the tube spherical portion can be effectively cooled, and thus the life of the light emission tube can be increased.

### BRIEF DESCRIPTION OF THE DRAWINGS

The invention will be described with reference to the accompanying drawing, wherein like numbers reference to like elements.

FIG. 1 illustrates an optical system of a projector 1000 according to an embodiment.

FIGS. 2A through 2C are views for explaining a light source device 110.

FIG. 3 shows spectral characteristics of a transmission increasing film 70.

FIGS. 4A and 4B are views for explaining a transmission increasing film 70a in a modified example.

### DESCRIPTION OF EXEMPLARY EMBODIMENT

A projector according to an embodiment of the invention is hereinafter described with reference to the drawings.

### Embodiment

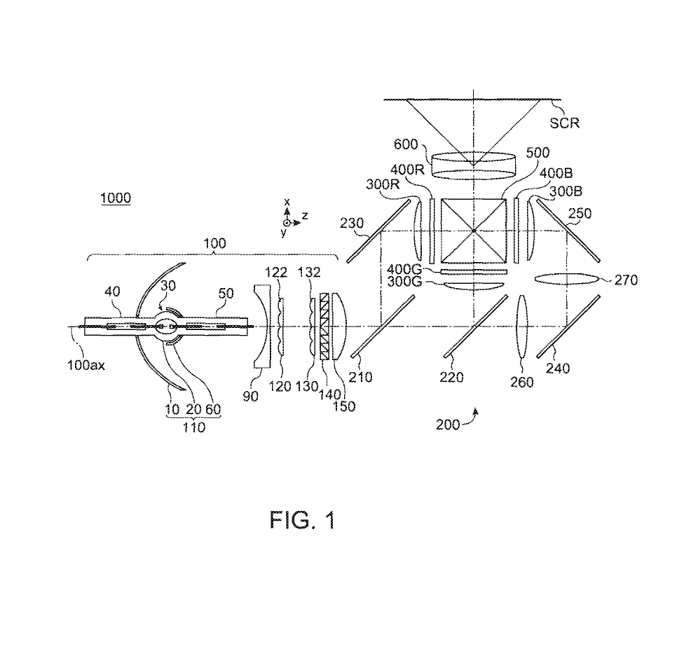

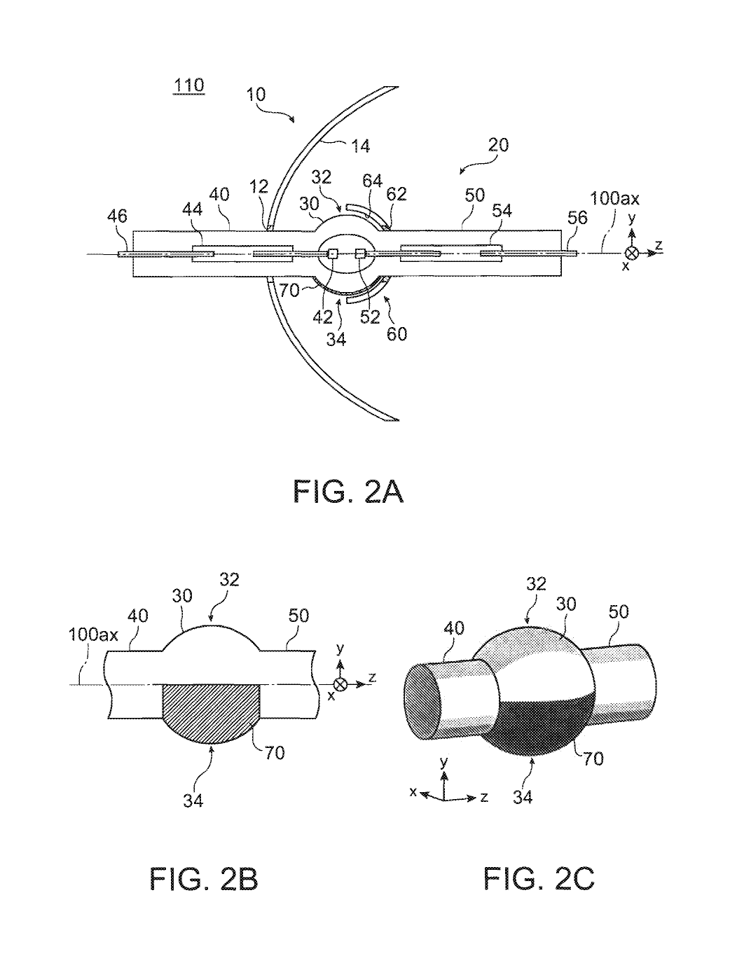

FIG. 1 illustrates an optical system of a projector 1000 according to the embodiment. FIGS. 2A through 2C are views for explaining a light source device 110, in which: FIG. 2A schematically illustrates the light source device 110; FIG. 2B is a side view of a tube spherical portion 30; and FIG. 2C is a perspective view of the tube spherical portion 30. In FIGS. 2B and 2C, a sub mirror 60 is removed from the light source device 110 so that the details of the condition of a transmission increasing film 70 formed on the outside surface of the tube spherical portion 30 can be clearly shown.

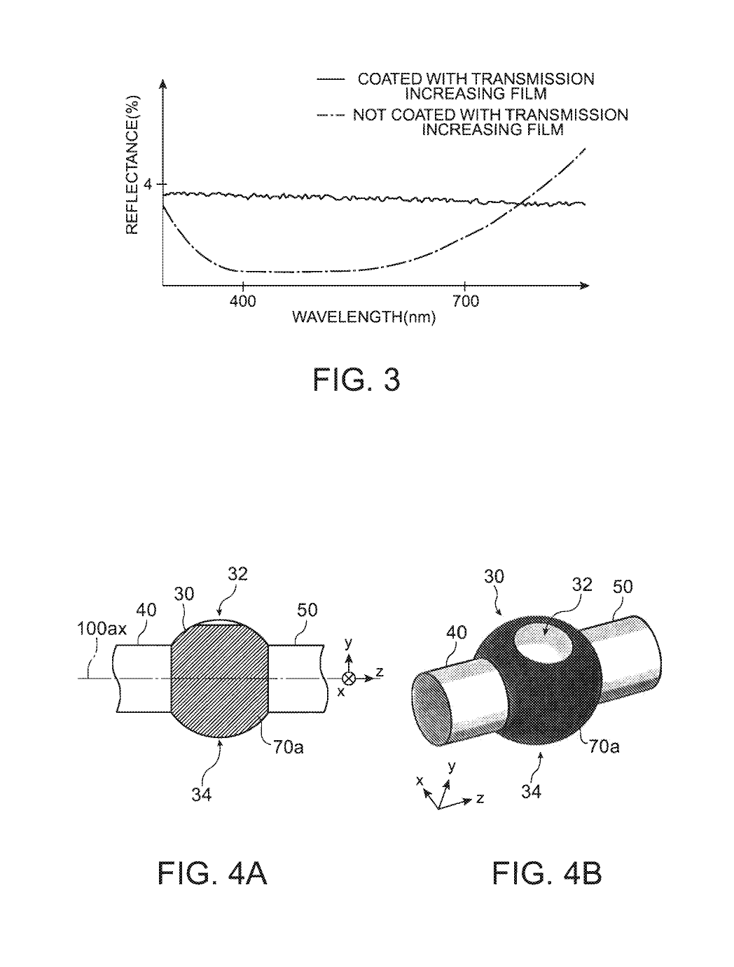

FIG. 3 explains spectral characteristics of the transmission increasing film 70. This figure shows spectral characteristics of an area having no coating of the transmission increasing film 70, as well as those of an area coated with the transmission increasing film 70.

In the following description, three mutually orthogonal directions defined as: a z-axis direction (direction of illumination optical axis 110ax in FIG. 1); an x-axis direction (direction parallel to the sheet surface of FIG. 1 and orthogonal to the z-axis); and a y-axis direction (direction perpendicular to the sheet surface of FIG. 1 and orthogonal to the z-axis) are used.

In the following description, the projector 1000 is disposed in a so-called installation condition as an example. Thus, the direction of the gravity corresponds to the downward direction (for example, y(−) direction in FIG. 2A).

As illustrated in FIG. 1, the projector 1000 according to this embodiment includes an illumination device 100, a color division and introduction optical system 200 for dividing illumination light emitted from thee illumination device 100 into three color lights of red light, green light and blue light and introducing the divided color lights to an illumination-receiving area, three liquid crystal devices 400R, 400G and 400B as electro-optic modulating devices for modulating each of the three color lights divided by the color division and introduction optical system 200 according to image information, a cross dichroic prism 500 for synthesizing the color lights modulated by the three liquid crystal devices 400R, 400G and 400B, and a projection optical system 600 for protecting light produced by the synthesis of the cross dichroic prism 500 on a projection surface such as a screen SCR.

The illumination device 100 contains the light source device 110 for emitting illumination light toward the illumination-receiving area, a concave lens 90 for releasing converged light received from the light source device 110 as substantially collimated light, a first lens array 120 having a plurality of first small lenses 122 for dividing the illumination light released from the concave lens 90 into a plurality of partial lights, a second lens array 130 having a plurality of second small lenses 132 corresponding to the plural first small lenses 122 of the first lens array 120, a polarization converting element 140 for converting the respective partial lights released from the second lens array 130 into substantially one type of linearly polarized lights having the same polarization direction, and a superposing lens 150 for superposing the respective partial lights released from the polarization converting element 140 on the illumination-receiving area.

As illustrated in FIGS. 1 and 2A, the light source device 110 has an ellipsoidal reflector 10 as a reflector, a light emission tube 20 having its light emission center near a first focus of the ellipsoidal reflector 10, and a sub mirror 60 as a reflection unit. The light source device 110 emits light having he illumination optical axis 100ax as its center axis.

As illustrated in FIG. 2A, the light emission tube 20 has the tube spherical portion 30 containing a pair of electrodes 42 and 52 disposed on the illumination optical axis 100ax, a pair of sealing portions 40 and 50 extending from both sides of the tube spherical portion 30, a pair of metal foils 44 and 54 sealed within the pair of the sealing portions 40 and 50, and a pair of leads 46 and 56 electrically connected with the pair of the metal foils 44 and 54.

Examples of requirements or the like which should be satisfied by the components of the light emission tube 20 are as follows. The tube spherical portion 30 and the sealing portions 40 and 50 are made of quartz glass, for example. Mercury, rare gas, and a small volume of halogen are sealed within the tube spherical portion 30. The electrodes 42 and 52 are tungsten electrodes, for example, and the metal foils 44 and 54 are molybdenum foils, for example. The leads 46 and 56 are formed by molybdenum or tungsten, for example.

The light emission tube 20 may be various types of light emission tube which emits light having high luminance. For example, a high-pressure mercury lamp, an extra-high pressure mercury lamp, a metal halide lamp, or others may be used.

As illustrated in FIG. 2A, the transmission increasing film 70 is formed on an area of the outside surface of the tube spherical portion 30 containing a lower side peak 34 with respect to the gravity. The transmission increasing film 70 includes a multiple layer of tantalum oxide (Ta₂O₅) and silicon oxide (SiO₂). As shown in FIG. 3, the transmission increasing film 70 has characteristics that its reflectance is lower for light in the wavelength range from 400 nm to 700 nm than that for light in other wavelength ranges. That is, according to the characteristics of the transmission increasing film 70, an area coated with the transmission increasing film 70 obtains higher light transmissivity for light in the range from 400 nm to 700 nm than that of an area having no coating of the transmission increasing film 70.

The transmission increasing film 70 is not formed on an area of the outside surface of the tube spherical portion 30 containing an upper side peak 32 with respect to the gravity.

More specifically, the transmission increasing film 70 is formed on the outside surface of the tube spherical portion 30 on the lower side (y(−) side) of a boundary plane as a virtual plane containing the Illumination optical axis 100ax and the x axis, and the transmission increasing film 70 is not formed on the outside surface of the tube spherical portion 30 on the upper side (y(+) side) of the virtual plane.

The transmission increasing film 70 may be formed on the outside surface of the tube spherical portion 30 by various methods such as deposition, dipping, ion-plating, and sputtering. For example, the transmission increasing film 70 can be formed only on the area of the outside surface of the tube spherical portion 30 containing the lower side peak 34 (outside surface of the tube spherical portion 30 on the lower side (y(−) side) of the virtual plane) by covering the area on which the transmission increasing film 70 is not formed (outside surface of the tube spherical portion 30 on the upper side (y(+)) of the virtual plane) using masking tape or the like, and alternately evaporating tantalum oxide (Ta₂O₅) and silicon oxide (SiO₂) while rotating and revolving the light emission tube 20.

As illustrated in FIG. 2A, the ellipsoidal reflector 10 has an opening 12 through which the sealing portion (one sealing portion) 40 of the light emission tube 20 is inserted to be fixed thereto, and a reflection concave surface 14 for reflecting light emitted from the light emission tube 20 toward the second focus position. The ellipsoidal reflector 10 is fixed to the sealing portion 40 of the light emission tube 20 by inorganic adhesive such as cement injected into the opening 12 of the ellipsoidal reflector 10.

Appropriate examples of the base material constituting the reflection concave surface 14 include crystallized glass, alumina (Al₂O₃), and other materials. A visible light reflection layer including a dielectric multi-layer of titanium oxide (TiO₂) and silicon oxide (SiO₂) is formed on the inside surface of the reflection concave surface 14, for example.

The sub mirror 60 is a reflection unit covering substantially half of the tube spherical portion 30 and opposed to the reflection concave surface 14 of the ellipsoidal reflector 10, and has an opening 62 through which the sealing portion (the other sealing portion) 50 of the light emission tube 20 is inserted to be fixed thereto, and a reflection concave surface 64 for reflecting light having been emitted from the light emission tube 20 toward the illumination-receiving area such that the light is directed toward the light emission tube 20. The light reflected by the sub mirror 60 passes through the light emission tube 20 and enters the ellipsoidal reflector 10. The sub mirror 60 is fixed to the sealing portion 50 of the light emission tube 20 by inorganic adhesive such as cement injected into the opening 62 of the sub mirror 60.

The material of the reflection concave surface 64 is light-transmissive alumina, for example. This material increases heat release from the sub mirror 60. Materials other than alumina such as quartz glass, sapphire, and ruby may be used for the reflection concave surface 64.

A reflection layer including a dielectric multi-layer film of tantalum oxide (Ta₂O₅) and silicon oxide (SiO₂), for example, is formed on the inside surface of the reflection concave 64.

As illustrated in FIG. 1, a concave lens 90 is disposed next to the ellipsoidal reflector 10 on the illumination-receiving area side. The concave lens 90 is so designed as to receive light from the ellipsoidal reflector 10 and release the light toward the first lens array 120.

The first lens array 120 has a function as a light division optical element which divides light received from the concave lens 90 into plural partial lights. The first lens array 120 has a plurality of first small lenses 122 on a plane orthogonal to the illumination optical axis 100ax. The first small lenses 122 have plural lines and plural rows to be disposed in matrix. Though not shown in the figures, the external shape of the first small lenses 122 is similar to the shape of the image forming area of the liquid crystal devices 400R, 400G and 400B.

The second lens array 130 has a function for forming respective images from the first small lenses 122 of the first lens array 120 approximately on the image forming area of the liquid crystal devices 400R, 400G and 400B in cooperation with the superposing lens 150. The second lens array 130 has substantially the same structure as that of the first lens array 120. That is, the second lens array 130 has plural second small lenses 132 on a plane orthogonal to the illumination optical axis 110ax, and the second small lenses 132 have plural lines and plural rows to be disposed in matrix.

The polarization converting element 140 is a polarization converting element which converts the polarization direction of the respective partial lights divided by the first lens array 120 into substantially one type of linearly polarized lights having the same polarization direction, and releases the converted lights.

The polarization converting element 140 has a polarization dividing layer which transmits one of the linear polarization components contained in the polarization components of the illumination light emitted from the light source device 110 and reflects the other linearly polarized component in the direction vertical to the illumination optical axis 100ax, a reflection layer for reflecting the other linear polarization component reflected by the polarization dividing layer in the direction parallel with the illumination optical axis 100ax, and a phase difference plate for converting the one linear polarization component having passed through the polarization dividing layer into the other linear polarization component.

The superposing lens 150 is an optical element which collects the plural partial lights having passed through the first lens array 120, the second lens array 130, and the polarization converting element 140 and superposes these lights approximately on the image forming area of the liquid crystal devices 400R, 400G and 400B. The superposing lens 150 is disposed in such a position that the optical axis of the superposing lens 150 substantially coincides with the illumination optical axis 100ax of the illumination device 100. The superposing lens 150 may be a combined lens produced by combining a plurality of lenses.

The color division and introduction optical system 200 has dichroic mirrors 210 and 220, reflection mirrors 230, 240 and 250, an entrance side lens 260, and a relay lens 270. The color division and introduction optical system 200 has a function for dividing illumination light released from the superposing lens 150 into three color lights of red light, green light and blue light, and introducing the respective color lights to the three liquid crystal devices 400R, 400G and 400B as devises having illumination-receiving areas.

Light collecting lenses 300R, 300G and 300B are disposed on the optical axis before the liquid crystal devices 400R, 400G and 400B, respectively.

The liquid crystal devices 400R, 400G and 400B modulate illumination light according to image information, and are the illumination-receiving units which receive illumination light from the illumination device 100.

The liquid crystal devices 400R, 400G and 400B have a pair of transparent glass substrates and liquid crystals as electro-optic substances sealed between the glass substrates. For example, the liquid crystal devices 400R, 400G and 400B modulate the polarization direction of one type of linearly polarized lights received through entrance side polarization plates according to given image information using polysilicon TFTs as switching elements.

Through not shown in the figures, an entrance side polarization plate is interposed between each pair of the light collecting lenses 300R, 300G and 300B and the liquid crystal devices 400R, 400G and 400B, and an exit side polarization plate is interposed between each of the liquid crystal devices 400R, 400G and 400B, and the cross dichroic prism 500. These entrance side polarization plate, liquid crystal devices 400R, 400G and 400B and exit side polarization plate modulate respective color lights.

The cross dichroic prism 500 is an optical element which synthesizes optical images produced by modulating the respective color lights released from the exit side polarization plates to form a color image. The cross dichroic prism 500 has a substantially square shape in the plan view having four rectangular prisms affixed to each other. Dielectric multi-layer films are formed on the substantially X-shaped boundary planes of the mutually affixed rectangular prisms. The dielectric multi-layer film formed on one of the substantially X-shaped boundary planes reflects red light, and the dielectric multi-layer film formed on the other boundary plane reflects blue light. The red and blue lights are bent by these dielectric multi-layer films so that these lights have the same advancing direction as that of the green light. By this step, the three color lights are synthesized.

The color image released from the cross dichroic prism 500 is enlarged and projected by the projection optical system 600 so that a large screen image can be formed on the screen SCR.

In the projector 1000 having the above structure according to this embodiment, the transmission increasing film 70 is not formed on the area of the outside surface of the tube spherical portion 30 containing the upper side peak 32 with respect to the gravity. Since this area has no coating of anti-reflection film as well, overall increase in temperature of the tube spherical portion 30 is prevented compared with the related-art light source device which has anti-reflection film on the entire outside surface of the tube spherical portion.

According to the projector 1000 in this embodiment which does not have the transmission increasing film 70 on the area of the outside surface of the tube spherical portion 30 containing the upper side peak 32 with respect to the gravity, overall increase in temperature of the tube spherical portion 30 can be avoided. Thus, the temperature of the upper side peak 32 of the tube spherical portion 30 does not rise, and regional expansion or whitening is not caused at the upper side peak 32 of the tune spherical portion 30. As a result the life of the light source device 110 is not shortened.

According to the projector 1000 in this embodiment which has the transmission increasing film 70 on the area of the outside surface of the tube spherical portion 30 containing the lower side peak 34 with respect to the gravity, the transmittance of the area coated with the transmission increasing film 70 for light in the visible range is higher than that of the area having no coating of the transmission increasing film 70. Thus, the entire light utilization efficiency increases.

Therefore, the projector 1000 according to this embodiment can prevent overall increase in temperature of the tube spherical portion 30 while increasing light utilization efficiency, and also prevent decrease in the life span of the light source device 110.

According to the projector 1000 in this embodiment, the transmission increasing film 70 has characteristics that the light transmittance of the area coated with the transmission increasing film 70 for light in the range from 400 nm to 700 nm is higher than that of the area having no coating of the transmission increasing film 70. Thus, visible light released from the lower side peak 34 of the tube spherical portion 30 can be more efficiently utilized.

According to the projector 1000 in this embodiment, the transmission increasing film 70 is formed by the multi-layer film of tantalum oxide (Ta₂O₅) and silicon oxide (SiO₂). Thus, the transmission increasing film 70 has higher heat resistance, and maintains preferable and long-term transmittance increasing characteristics for the surface of the tube spherical portion 30 of the light emission tube 20 exposed to extremely high temperature.

According to the projector 1000 in this embodiment, the light source device 110 further has the sub mirror 60 as the reflection unit disposed near the sealing portion 50 in such a condition as to cover the illumination-receiving area side outer surface of the tube spherical portion 30. In this case, light emitted from the light emission tube 20 toward the illumination-receiving area side is reflected by the sub mirror 60 toward the ellipsoidal reflector 10. As a result, light emitted from the light emission tube 20 toward the illumination-receiving area and not efficiently used in the related art can be effectively utilized. Thus, luminance of images produced by the projector 1000 increases.

In addition, the ellipsoidal reflector 10 does not require the size sufficient for covering the whole light emission tube 20 containing its end on the illumination-receiving area side. Thus, the ellipsoidal reflector 10 can be miniaturized, and therefore the projector can be made compact. Since the ellipsoidal reflector 10 is small, the sizes of the components disposed on the optical path after the ellipsoidal reflector 10 can be decreased. As a result, size reduction of the projector can be further achieved.

As described above, improvement over light utilization efficiency and miniaturization of the ellipsoidal reflector 10 are achieved by providing the sub mirror 60 on the sealing portion 50 of the light emission tube 20. Consequently, the high-luminance and compact projector can be provided. However, since substantially half of the tube spherical portion 30 is covered by the sub mirror 60, the temperature of the tube spherical portion 30 of the projector 1000 having the sub mirror 60 on the sealing portion 50 of the light emission tube 20 easily rises compared with a projector having no sub mirror of this type.

According to the projector in this embodiment of the invention, increase in the temperature of the entire tube spherical portion 30 is prevented as described above. Therefore, this advantage is particularly effective for such a protector as the projector 1000 which has the sub mirror 60 on the sealing portion 50 of the light emission tube 20 in this embodiment.

In the projector 1000 having the sub mirror 60 on the sealing portion 50 of the light emission tube 20, light emitted from the light emission tube 20 and reflected by the sub mirror 60 passes through the outside surface of the tube spherical portion 30 several times until the light emitted from the light emission tube 20 and reflected by the sub mirror 60 again passes through the inside of the light emission tube 20 and enters the ellipsoidal reflector 10.

As discussed above, the transmittance of the outside surface of the tube spherical portion 30 for visible light passing therethrough is raised according to this embodiment of the invention. Thus, this advantage is particularly effective for such a projector as the projector 1000 which has the sub mirror 60 on the sealing portion 50 of the light emission tube 20 in this embodiment.

According to the projector 1000 which has the sub mirror 60 on the sealing portion 50 of the light emission tube 20, a space is produced between the tube spherical portion 30 and the sub mirror 60. In this case, the tube spherical portion 30 can be effectively cooled, and thus the life of the light emission tube 20 can be increased.

While the projector according to the particular embodiment of the invention has been shown and described, it will be obvious that the invention may be practiced otherwise than as specifically described herein without departing from the scope of the invention. For example, the following modifications may be made.

(1) According to the projector 1000 in the above embodiment, the transmission increasing film 70 is formed on the outside surface of the tube spherical portion 30 such that the surface area of the tube spherical portion 30 coated with the transmission increasing film 70 is substantially the same as the surface area of the tube spherical portion 30 having no coating of the transmission increasing film 70 as illustrated in FIGS. 2B and 2C. However, the transmission increasing film may be provided in other conditions.

FIGS. 4A and 4B are views for explaining a transmission increasing film 70a according to a modified example. FIG. 4A is a side view of the tube spherical portion 30 in the modified example, and FIG. 4B is a perspective view of the tube spherical portion 30 in the modified example. In FIGS. 4A and 4B, the same reference numerals are given to the same components as those shown in FIGS. 2B and 2C, and detailed explanation of those components is not repeated herein. The transmission increasing film 70a includes a multi-layer film of tantalum oxide (Ta₂O₅) and silicon oxide (SiO₂) similarly to the transmission increasing film 70 discussed in the above embodiment, and therefore has characteristics that light transmittance of an area coated with the transmission increasing film 70a is higher for light in the range from 400 nm to 700 nm than that of an area having no coating of the transmission increasing film 70a.

As illustrated in FIGS. 4A and 4B, the transmission increasing film 70a in the modified example may be formed on the outside surface of the tube spherical portion 30 such that the surface area of the tube spherical portion 30 coated with the transmission increasing film 70a is equal to or larger than the surface area of the tube spherical portion 30 having no coating of the transmission increasing film 70a. When the transmission increasing film 70a is provided on an area of the tube spherical portion 30 other than a region containing the upper side peak 32 as illustrated in FIGS. 4A and 4B, light utilization efficiency improves while preventing temperature rise in the entire tube spherical portion 30 and decrease in the life span of the light source device 110 (not shown).

(2) According to the projector 1000 in the above embodiment, the light source device 110 having the sub mirror 60 as a reflection unit on the light emission tube 20 is used. However, the invention is applicable to a projector which employs a light source device having no sub mirror.

(3) According to the projector 1000 in the above embodiment, the ellipsoidal reflector is used as a reflector. However, a parabolic reflector can be appropriately used.

(4) According to the projector 1000 in the above embodiment, the lens integrator optical system including the lens arrays is used as an equalizing optical system. However, a rod integrator optical system including rod members can be appropriately used.

(5) While the projector 1000 in the above embodiment is a transmissive-type projector, the invention is applicable to a reflection-type projector. In the “transmissive-type” projector, an electro-optic modulating device as a light modulating device such as a transmissive-type liquid crystal device transmits light. In the “reflection-type” projector, an electro-optic modulating device as a light modulating device such as a reflection-type liquid crystal device reflects light. Even when the invention is applied to the reflection-type projector, advantages similar to those of the transmissive-type projector can be provided.

(6) While the projector 1000 in the above embodiment uses the three liquid crystal devices 400R, 400G and 400B, the invention is applicable to a projector provided with one, two, four or more liquid crystal devices.

(7) While the projector 1000 in the above embodiment uses the liquid crystal device as electro-optic modulating device, other types of electro-optic modulating device may be employed. Generally, any types of the electro-optic modulating device may be used if they can modulate entering light according to image information, and a micro-mirror-type light modulating device may be employed, for example. A DMD (digital micro-mirror device, trademark of Texas Instruments Inc.) can be used as the micro-mirror-type light modulating device, for example.

(8) The invention is applicable to a projector used in both a so-called installation condition and a so-called hanging condition.

(9) The invention is applicable to both a front-projection-type projector which projects a projection image from the watching side, and a rear-projection-type projector which projects a projection image from the side opposite to the watching side.

The entire disclosure of Japanese Patent Application No. 2006-258821, filed Sep. 25, 2006 is expressly incorporated by reference herein.

What is claimed is:

1. A projector, comprising:
a light source device that includes
a light emission tube which has a tube spherical portion containing a pair of electrodes, and a pair of sealing portions extending from both sides of the tube spherical portion, both of the electrodes and the sealing portions being disposed along an illumination optical axis, and
a reflector which is disposed near one of the sealing portions of the light emission tube and reflects light emitted from the light emission tube toward an illumination-receiving area;
an electro-optic modulating device that modulates illumination light emitted from the light source device according to image information; and
a protection optical system that projects light modulated by the electro-optic modulating device,
wherein
a transmission increasing film is formed on an area of the outside surface of the tube spherical portion containing a lower side peak with respect to the gravity,
the transmission increasing film is not formed on an area of the outside surface of the tube spherical portion containing an upper side peak with respect to the gravity, and
the transmission increasing film has characteristics that transmittance of an area coated with the transmission increasing film for light in a visible range is higher than an area having no coating of the transmission increasing film.

2. The projector according to claim 1, wherein the transmission increasing film has characteristics that transmittance of an area coated with the transmission increasing film for light in the range from 400 nm to 700 nm is higher than an area having no coating of the transmission increasing film.

3. The projector according to claim 1, wherein the transmission increasing film has a multi-layer film containing Ta₂O₅ and SiO₂.

4. The projector according to claim 1, wherein the transmission increasing film is formed on the outside surface of the tube spherical portion such that the surface area of the tube spherical portion coated with the transmission increasing film is equal to or larger than the surface area of the tube spherical portion having no coating of the transmission increasing film.

5. The projector according to claim 1, wherein the light source device further includes a reflection unit which is disposed near the other sealing portion of the light emission tube in such a condition as to cover the outside surface of the illumination-receiving area side in the tube spherical portion, and reflects light emitted from the light emission tube such that the light can be directed toward the light emission tube.
